(19) United States
(12) Patent Application Publication
(10) Pub. No.: US 2016/0045027 A1
(43) Pub. Date: Feb. 18, 2016

(54) FLIP CORE DOOR ASSEMBLY

(71) Applicant: Gil Alkoby, North Hollywood, CA (US)

(72) Inventor: Gil Alkoby, North Hollywood, CA (US)

(21) Appl. No.: 14/458,156

(22) Filed: Aug. 12, 2014

(51) Int. Cl. A47B 96/20; E06B 3/72; E06B 5/00

(52) U.S. Cl. CPC A47B 96/20; E06B 5/006; E06B 3/72; E06B 2003/7013

(57) ABSTRACT

A flip core door assembly comprises an outer frame structure, inner panel and a plurality of flexible strips. The outer frame structure includes an upper frame member, a lower frame member, and a pair of opposing frame members. The inner panel includes a front side, a rear side, an upper side member, a lower side member and a pair of opposing side members. The inner panel is adaptable to place in an open space of the outer frame structure. The plurality of flexible strips is attached to the upper side member, the lower side member and the pair of opposing side members. The plurality of flexible strips is adaptable to secure the inner panel air tightly with the outer frame structure which allows a user to easily remove the inner panel thereby flipping the inner panel within the outer frame structure.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE DISCLOSURE

This embodiment relates to cabinet doors, and more particularly to a flip core door assembly having a plurality of flexible strips that is designed to allow flipping of an inner panel to provide different viewing patterns.

### DISCUSSION OF RELATED ART

One of the most common structures for cabinet doors comprises an outer frame and an inner panel, supported by and connected to the frame. The cabinet door provides access into an interior of the cabinet or a drawer. The cabinet may be free-standing, such as for an entertainment center, or built in, such as in a kitchen, as known in the art. Commonly, the front of the cabinet door is decorative in appearance. This decoration may include a variety of artistic techniques, decorative moldings, colors, textures or patterns. In the case of some other cabinet doors, the inner panel lends itself to use as a location for the placement of different viewing patterns, which can be replaced. This enables the use of selected decorative materials for special occasions. such as the changes of the seasons. However, these existing mechanisms do not allow for the easy changing of the inner panels of cabinet doors.

An existing cabinet door assembly containing a wooden cabinet door with a peripheral frame and an open center enables a fabric panel to be mounted on the door in a manner such that the panel may be readily removed and replaced with other panels. An upper member of the frame has a slot which receives a dowel pin carried in an upper loop of the panel fabric, and a lower frame member has a slot which receives the lower end of the panel and directs a lower dowel pin carried at the lower end into a capturing position. The panel is pulled tightly by tension applied to the dowel pins. However, it is difficult to install, remove and replace the panels without damaging or marring the structure.

Another existing door system includes a door body and panel inserts. A first side edge of the door body includes door hinges and a second side edge is provided with one or more slots. The door body includes one or more windows, each communicating with a slot. A channel is provided on the inner aspect of each window. Each of the panel inserts includes a frame defining a central opening. The frame may be received into the slot and rest in snug fitting engagement in the channel, disposing the central opening within the window. A mesh screen is mounted on the frame of one or more panel inserts and occupies the central opening. An air impervious pane is likewise mounted on the frame of other panel inserts. The panel inserts may be interchangeably installed and are retained in place by a slidable bolt mounted on the second side edge. However, it is difficult to replace the panel when used in low level cabinets and the panel can be frequently stuck while sliding the panel through the frame.

Yet another existing cabinet front includes a generally planar base portion and a frame portion having a recessed portion and a securing portion, wherein the securing portion is fixedly mounted to the base portion. A channel is formed between the frame portion, the securing portion and the base portion. The cabinet front includes a reversible, decorative panel slidably positioned within the channel. However the cabinet doors do not allow for the user to easily change the appearance of the cabinets without extensive time, labor and money. Moreover, the device does not allow for the easy changing of the inner panels of cabinet doors without using tools or retaining a skilled carpenter.

Therefore, there is a need for an economical and improved flip core door assembly that would allow the user to quickly and easily flip an inner panel of the flip core door assembly. Such a needed flip core door assembly would have flexible strips that are adaptable to secure the inner panel air-tightly with the outer frame structure. Further the inner panel would have different viewing patterns on front and rear sides. Finally the flexible strips would allow the user to easily remove the inner panel by flipping the inner panel within the outer frame structure. The present embodiment accomplishes these objectives.

### SUMMARY OF THE DISCLOSURE

The present embodiment is a flip core door assembly comprising an outer frame structure having an upper frame member, a lower frame member, a pair of opposing frame members and an open space defined between the upper frame member, the lower frame member and the pair of opposing side frame members. An inner panel is adaptable to place in the open space of the outer frame structure. The inner panel includes a front side, a rear side, an upper side member, a lower side member and a pair of opposing side members. The inner panel is adaptable to provide different viewing patterns on the front side and the rear side.

The flip core door assembly further comprises a plurality of flexible strips that is removably attached to the upper side member, the lower side member and the pair of opposing side member when the inner panel is placed in the open space of the outer frame structure. The plurality of flexible strips is adaptable to secure the inner panel air tightly with the outer frame structure. The plurality of flexible strips provides a convenient way to interchange the viewing patterns within the cabinet doors to permit variations in the decoration of the cabinet. The outer frame structure comprises a cabinet door. The inner panel is adaptable to provide different viewing pattern on the front side. Also, the inner panel is adaptable to provide another different viewing pattern on the rear side. The flip core door assembly is utilized with a location comprises any of household goods, kitchen articles, an office, a work room and a bath articles. The plurality of flexible strips is made of plastic.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 illustrates an exploded view of a flip core door assembly in accordance with a preferred embodiment of the present invention;

FIG. 2 illustrates a perspective view of the flip core door assembly showing a front side of an inner panel in accordance with the preferred embodiment of the present invention;

FIG. 3 illustrates a perspective view of the flip core door assembly showing a rear side of the inner panel with a plurality of flexible strips partially removed in accordance with the preferred embodiment of the present invention;

FIG. 4 illustrates a perspective view of the flip core door assembly in which the inner panel is flipped in accordance with the preferred embodiment of the present invention;

FIG. 5 illustrates a perspective view of the flip core door assembly showing the front side of the inner panel attached with the plurality of flexible strips in accordance with the preferred embodiment of the present invention;

FIG. 6 illustrates a perspective view of the flip core door assembly showing the rear side of the inner panel in accordance with the preferred embodiment of the present invention; and

FIG. 7 illustrates a perspective view of the flip core door assembly when in use.

### DETAILED DESCRIPTION OF THE PREFERRED EMBODIMENT

The following describes example embodiments in which the present invention may be practiced. This invention, however, may be embodied in many different ways, and the description provided herein should not be construed as limiting in any way. Among other things, the following invention may be embodied as methods or devices. As such, the present invention may take the form of an entirely hardware embodiment, an entirely software embodiment, or an embodiment combining software and hardware aspects. The following detailed descriptions should not be taken in a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

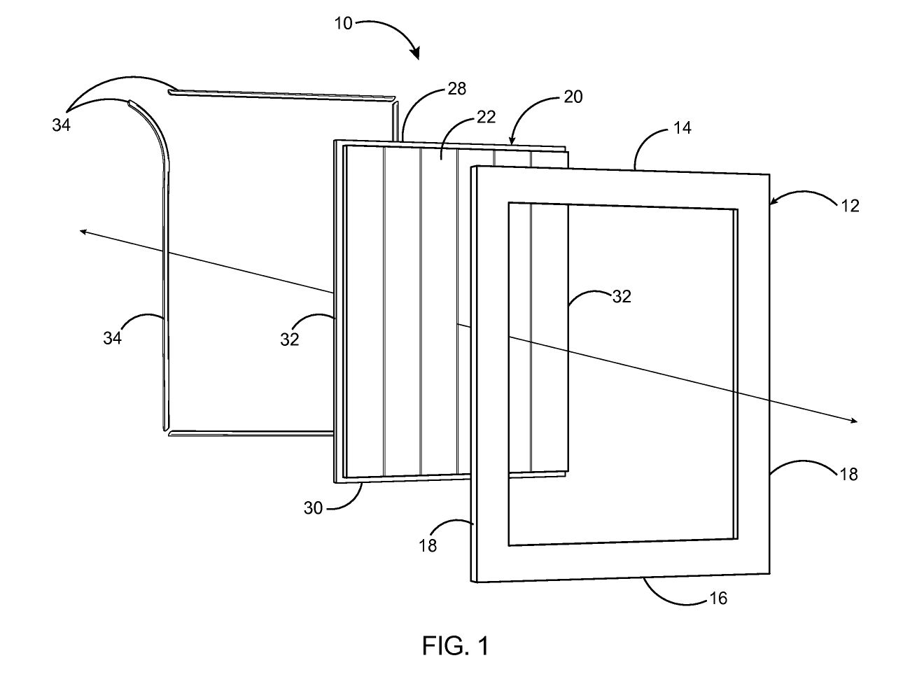

FIG. 1 illustrates an exploded view of a flip core door assembly 10 in accordance with a preferred embodiment of the present invention. The flip core door assembly 10 comprises an outer frame structure 12 having an upper frame member 14, a lower frame member 16, a pair of opposing frame members 18 and an open space defined between the upper frame member 12, the lower frame member 14 and the pair of opposing side frame members 18. An inner panel 20 is adaptable to place in the open space of the outer frame structure 12. The inner panel includes a front side 22, a rear side 24, an upper side member 28, a lower side member 30 and a pair of opposing side members 32. The inner panel 20 includes different viewing patterns on the front side 22 and rear side 24. A plurality of flexible strips 34 is removably attached to the upper side member 14, the lower frame member 16 and the pair of opposing frame members 18 when the inner panel 20 is placed in the open space of the outer frame structure 12. The plurality of flexible strips 34 is adaptable to secure the inner panel 20 air tightly with the outer frame structure 12.

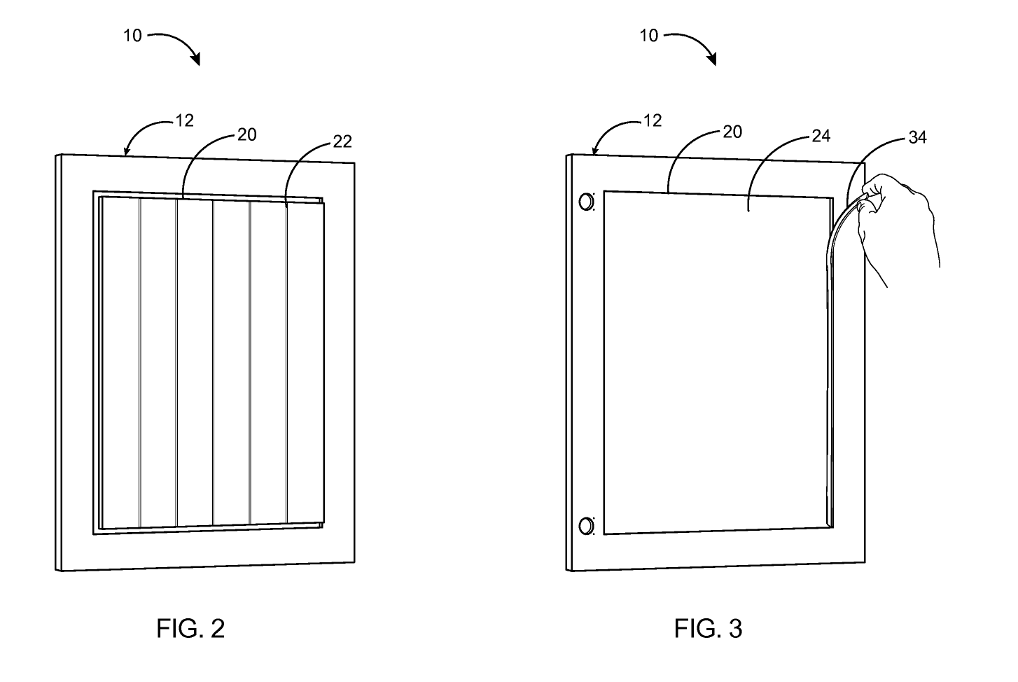

FIG. 2 illustrates a perspective view of the flip core door assembly 10 showing a front side 22 of the inner panel 20 in accordance with the preferred embodiment of the present invention. The inner panel 20 is placed in the open space of the outer frame structure 12. As shown in the FIG. 2, the plurality of flexible strips 34 is fixed in the rear side 24 of the inner panel 20 and displays the decorative viewing pattern on the front side 22 of the inner panel 20. The outer frame structure 12 comprises a cabinet door. The inner panel 20 is adaptable to provide different viewing pattern on the front side 22. Also, the inner panel 20 is adaptable to provide another different viewing pattern on the rear side 24. The plurality of flexible strips 34 is made of plastic. The flip core door assembly 10 is utilized with a location comprises any of household goods, kitchen articles, an office, a work room and bath articles.

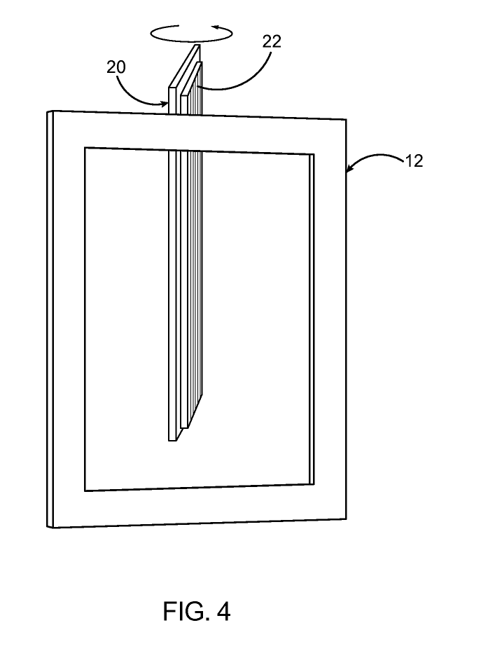

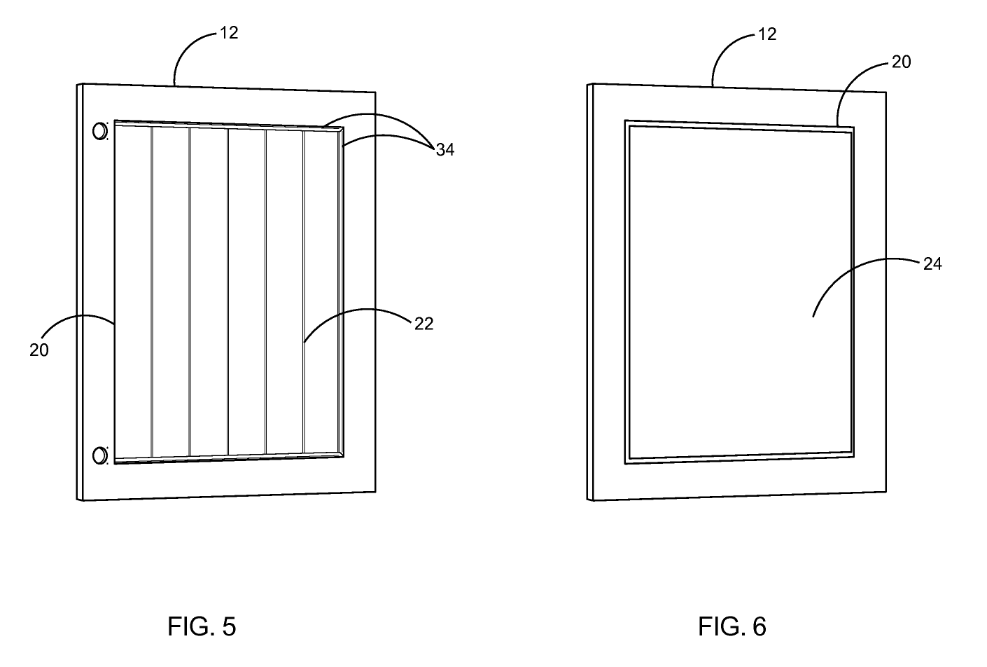

Referring to FIGS. 3, 4, 5 and 6, the flip core door assembly 10 provides an unchangeable or reversible inner panel 20 in accordance with the preferred embodiment of the present invention. The plurality of flexible strips 34 is removed from the rear side 24 of the inner panel 20, which allows the user to easily remove the inner panel 20 and flip the inner panel 20 within the outer frame structure 12. When the plurality of flexible strips 34 is removed from the front side 22 of the inner panel 20 and fixed in the rear side 24 of the inner panel 20, the inner panel 20 is reversed to provide viewing pattern in the front side 22 of the inner panel 20. Similarly, when the plurality of flexible strips 34 is removed from the rear side 24 of the inner panel 20 and fixed in the front side 22 of the inner panel 20, the inner panel 20 is reversed to provide viewing pattern in the rear side 24 of the inner panel 20.

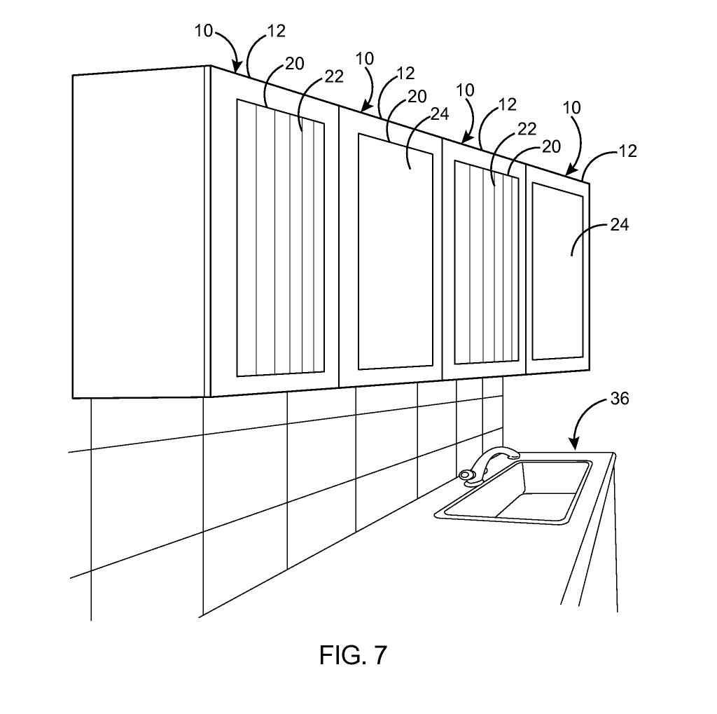

FIG. 7 illustrates a perspective view of the flip core door assembly 10 when in use. The flip core door assembly 10 is utilized with a kitchen cabinet as shown in FIG. 7. For example, in a customary installation, the flip core door assembly 10 may be located in the kitchen cabinet adjacent a sink and the inner panel 20 show the different viewing patterns on the front side 22 and rear side 24. The flip core door assembly 10 allows a user to change the appearance of door quickly, easily and economically according to the will of the user of the cabinet. The plurality of flexible strips 34, together, is cooperatively effective to the outer frame structure 12 and retains the inner panel 20 secured against the outer frame structure 12 of the flip core door assembly 10. The plurality of flexible strips 34 provides a convenient way to interchange the viewing patterns within the cabinet doors to permit variations in the decoration of the cabinet.

The preferred embodiment is commonly utilized with household kitchens and bathrooms. The inner panel 20 of the flip core door assembly 10 can be formed in a wide possibility of colors and designs. The flip core door assembly 10 can be fabricated from wood, plastic, or other suitable and aesthetically pleasing material.

While a particular form of the invention has been illustrated and described, it will be apparent that various modifications can be made without departing from the spirit and scope of the invention. For example, the inner panel 20 may be made of different materials or sizes that can be customized to fit with any cabinet door. Accordingly, it is not intended that the invention be limited, except as by the appended claims.

What is claimed is:

1. A flip core door assembly comprising:
an outer frame structure that includes an upper frame member, a lower frame member, a pair of opposing frame members and an open space defined between the upper frame member, the lower frame member and the pair of opposing side frame members;
an inner panel that includes a front side, a rear side, an upper side member, a lower side member and a pair of opposing side members, the inner panel being adaptable to place in the open space of the outer frame structure; and
a plurality of flexible strips attached to the upper side member, the lower side member and the pair of opposing side members when the inner panel being placed in the open space of the outer frame structure, the plurality of flexible strips being adaptable to secure the inner panel air tightly with outer frame structure;
whereby the plurality of flexible strips allows a user to easily remove the inner panel thereby flipping the inner panel within the outer frame structure.

2. The flip core door assembly of claim 1 wherein the inner panel includes different viewing patterns on front and rear sides.

3. The flip core door assembly of claim 1 wherein the plurality of flexible strips is made of plastic.

4. The flip core door assembly of claim 1 wherein the flip core door assembly is utilized with a location comprises any of household goods, kitchen articles, an office, a work room and a bath articles.

5. The flip core door assembly of claim 1 wherein the outer frame structure comprises a cabinet door.

6. A flip core door assembly comprising:
an outer frame structure that includes an upper frame member, a lower frame member, a pair of opposing frame members and an open space defined between the upper frame member, the lower frame member and the pair of opposing side frame members;
an inner panel that includes a front side, a rear side, an upper side member, a lower side member, a pair of opposing side members and different viewing patterns on the front and rear sides, the inner panel being adaptable to place in the open space of the outer frame structure; and
a plurality of flexible strips attached to the upper side member, the lower side member and the pair of opposing side members when the inner panel being placed in the open space of the outer frame structure, the plurality of flexible strips being adaptable to secure the inner panel air tightly with outer frame structure;
whereby the plurality of flexible strips allows a user to easily remove the inner panel thereby flipping the inner panel within the outer frame structure.

7. The flip core door assembly of claim 6 wherein the inner panel is adaptable to provide different viewing pattern on the front side.

8. The flip core door assembly of claim 6 wherein the inner panel is adaptable to provide different viewing pattern on the rear side.

9. The flip core door assembly of claim 6 wherein the plurality of flexible strips is made of plastic.

10. The flip core door assembly of claim 6 wherein the flip core door assembly is utilized with a location comprises any of household goods, kitchen articles, an office, a work room and a bath articles.

11. The flip core door assembly of claim 6 wherein the outer frame structure comprises a cabinet door.

12. A flip core door assembly comprising:
an outer frame structure including an upper frame member, a lower frame member, a pair of opposing frame members and an open space defined between the upper frame member, the lower frame member and the pair of opposing side frame members;
an inner panel including a front side, a rear side, an upper side member, a lower side member, a pair of opposing side members and different viewing patterns on front and rear sides, the inner panel being adaptable to place in the open space of the outer frame structure and interchangeable to provide selected viewing patterns; and
a plurality of flexible strips attached to the upper side member, the lower side member and the pair of opposing side member when the inner panel being placed in the open space of the outer frame structure, the plurality of flexible strips being adaptable to secure the inner panel air tightly with outer frame structure;
whereby the plurality of flexible strips allows a user to easily remove the inner panel thereby flipping the inner panel within the outer frame structure.

13. The flip core door assembly of claim 12 wherein the plurality of flexible strips is made of plastic.

14. The flip core door assembly of claim 12 wherein the flip core door assembly is utilized with a location comprises any of household goods, kitchen articles, an office, a work room and a bath articles.

15. The flip core door assembly of claim 12 wherein the outer frame structure comprises a cabinet door.
